(19) United States
(12) Patent Application Publication
(10) Pub. No.: US 2023/0044356 A1
(43) Pub. Date: Feb. 9, 2023

(54) DIGITAL AUDIO WORKSTATION AUGMENTED WITH VR/AR FUNCTIONALITIES

(71) Applicant: Spacia Labs Inc., Los Angeles, CA (US)

(72) Inventors: Lucas Todd, Los Angeles, CA (US); Facundo Diaz, Los Angeles, CA (US); Eli Libman, Los Angeles, CA (US); Michael Goldberg, Los Angeles, CA (US)

(21) Appl. No.: 17/590,777

(22) Filed: Feb. 1, 2022

Related U.S. Application Data
(60) Provisional application No. 63/144,904, filed on Feb. 2, 2021.

(51) Int. Cl. G10H 1/00; G06F 3/0482; G06F 3/04815; G06F 3/01; G06T 15/00; G06V 40/20; G06T 19/20

(52) U.S. Cl. CPC G10H 1/0008; G06F 3/0482; G06F 3/04815; G06F 3/017; G06F 3/011; G06T 15/00; G06V 40/20; G06T 19/20; G06T 2200/24; G06T 2219/2021; G06T 2219/2016; G10H 2220/131; G10H 2220/201; G10H 2220/455

(57) ABSTRACT

Embodiments of the present technology are directed at features and functionalities of a VR/AR enabled digital audio workstation. The disclosed audio workstation can be configured to allow users to record, produce, mix, and edit audio in virtual 3D space based on detecting and manipulating human gestures in a virtual reality environment. The audio can relate to music, voice, background noise, speeches, background noise, one or more musical instruments, special effects music, electronic humming or noise from electrical/mechanical equipment, or any other type of audio.

### CROSS-REFERENCE TO RELATED PATENT APPLICATIONS

This application claims priority to U.S. Provisional Patent Application No. 63/144,904, filed Feb. 2, 2021, entitled “DIGITAL AUDIO WORKSTATION AUGMENTED WITH VR/AR FUNCTIONALITIES,” the entire disclosure of which is herein incorporated by reference.

### TECHNICAL FIELD

This disclosure is related to digital audio workstations for use in composing, producing, recording, mixing and editing audio. More particularly, the embodiments disclosed herein are directed at systems, apparatuses, and methods to facilitate digital audio workstations equipped with augment reality (AR) and/or virtual reality (VR) technologies.

### BACKGROUND

A digital audio workstation (DAW) is a computer software used for music production. For example, a DAW allows users to record, edit, mix and master audio files. A user can record multiple tracks, which can be mixed together to create a final audio file. A singer's voice can be a track one, the instrumentals can be on track two, drums can be on track three, sound effects can be on track four, and so on. By adjusting the individual attributes (such as volume or pitch) of each track, the various tracks can be mixed, corrected, equalized, or otherwise edited into a single audio file. DAWs can also be used for the generation of audio using MIDI and virtual software instruments and effects modules. However, conventional DAW technology is based on an inherently 2-dimensional interface that is limited to the physical environment inside the studio. Further, conventional DAW technology offers little to no customizations and is constrained by unintuitive, inflexible controls.

### BRIEF DESCRIPTION OF THE DRAWINGS

FIG. 1 illustrates an overview of an environment in which the disclosed VR/AR enabled digital audio workstation is operative.

FIGS. 2A-2K illustrate examples of graphical user interfaces (GUIs) displaying digital representations of an audio track.

FIGS. 3A-3B illustrate examples of graphical user interfaces (GUIs) displaying audio tracks waveforms visualized within a box.

FIGS. 4A-4D illustrate examples of graphical user interfaces (GUIs) displaying audio track blocks.

FIGS. 5A-5C illustrate examples of graphical user interfaces (GUIs) for creating a virtual 3D mixing environment.

### DETAILED DESCRIPTION

Embodiments of the present technology are directed at features and functionalities of a VR/AR enabled digital audio workstation. The disclosed audio workstation can be configured to allow users to record, produce, mix, and edit audio in virtual 3D space based on detecting and manipulating human gestures to interact with virtual objects and modules in a virtual reality environment. The audio can relate to music, voice, background noise, speeches, one or more musical instruments, special effects music, electronic humming or noise from electrical/mechanical equipment, or any other type of audio. In some embodiments, a physical acoustical environment can be simulated as a virtual environment in which audio is mixed. The audio mixing interface can be a virtual user interface in which tracks are visualized as objects in a 3D space that has a size, shape, and certain properties. A user can visualize, navigate and interact with the tracks in 3D virtual space using hand gestures and/or body movements. In some embodiments, users can collaborate on audio production virtually within the same virtual digital audio workstation environment. For example, users can choose their own avatars and can explore various features and environments together or separately, e.g., one collaborator can be in a mixing mode (in a virtual mixing environment) while the other collaborator is in an arrangement mode (arranging tracks in a virtual environment). Details of various features disclosed herein will be better understood in view of the discussions that follow herein.

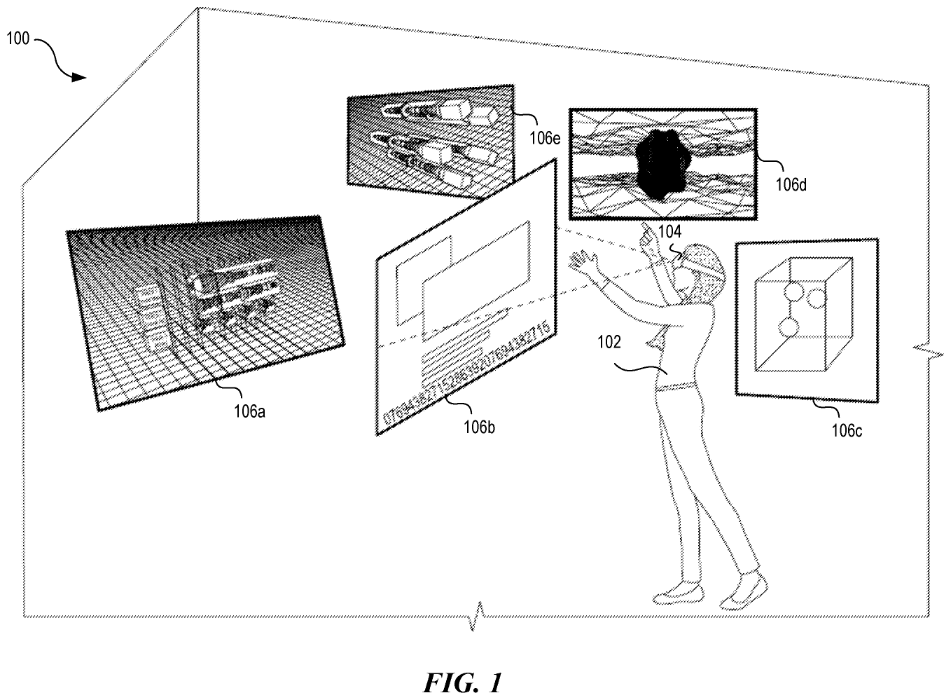

FIG. 1 illustrates an overview of an environment 100 in which the disclosed VR/AR enabled digital audio workstation (DAW) is operative. For example, FIG. 1 shows a user 102 wearing an AR/VR enabled device 104 (e.g., or generally a wearable computing device, such as a headset, with cameras to monitor the user's field of view to identify the user's hands or body parts) for manipulating audio tracks in a virtual studio/mixing environment represented in a 3 dimensional (3D) space displayed on a user interface 106 (106a, 106b, 106c, 106d, and 106e) of the AR/VR enabled headset. The user interface 106 can be at arm's length to the user 102 and display blocks of tracks, different effects that can be added to tracks, information related to various tracks that can be useful for creating an audio mix, one or more modules for manipulating audio tracks and the like. Thus, it can be appreciated that the virtual 3D space facilitates an immersive experience of the user with gestural control, stimulating visualizations and animations, which results in enhanced engagement, inspiration, creativity and control. For example, the user interface (displayed on the AR/VR enabled headset) can include traditional mixing board controls such as track sliders, knobs, gain levels, in addition to various other customizations offered by the disclosed VR/AR enabled DAW. In some embodiments, the user interface displays a selection for simulating different acoustical environments (e.g., a large cathedral, a long tunnel, or bathroom). By simulating different acoustical environments, the disclosed VR/AR enabled workstation can computationally generate reverb characteristics resembling such spaces. After simulating an acoustical environment, a user can place one or more audio tracks within the environment. For example, if the user loads a preset cathedral environment as a virtual mixing environment, the user will find himself or herself within a cathedral environment. The spacious, reverb-y qualities of the cathedral environment will be applied, and specifically based on where audio tracks are placed throughout the environment. In some embodiments, audio tracks can be recorded, loaded from a library of pre-recorded instrumentals, acapellas, loops, and samples, loaded from the user's own library of sounds, or generated by the disclosed VR/AR enabled digital audio workstation. The disclosed AR/VR enabled workstation provides several automations. For example, a user can simply hit automation record, drag and drop various “modes” on the user interface, point-and-draw an automation curve of a specific audio track, etc. Automation of nodes can be regarded as movement of mixdown points and audio nodes to produce an effect of motion, i.e., modeling real world sound events, such as a car driving by, or generally model a perspective of shifting audio. Modes can represent different aspects of audio production. For example, in some embodiments, the disclosed VR/AR enabled provides a user options to choose at least one mode from a mix mode, a collaborate mode, an arrangement mode, and a studio mode. Each of these modes can be associated with one or more modules that implement user-interface features such as drop-down menus, buttons, sliders, knobs, and the like. Details of these modes are described below.

### Mix Mode

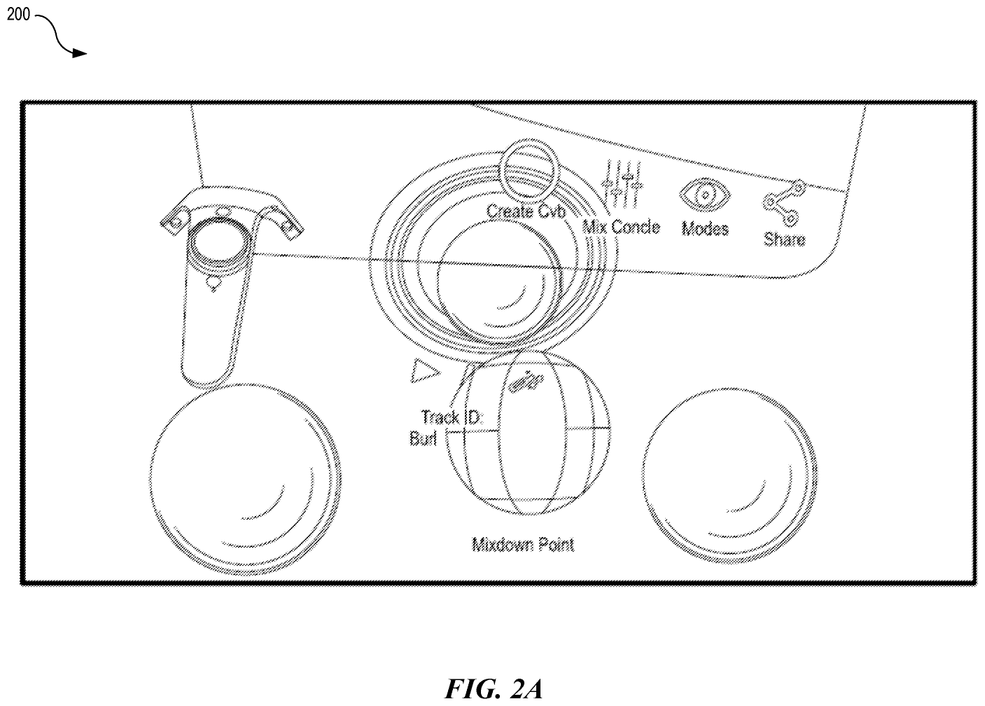

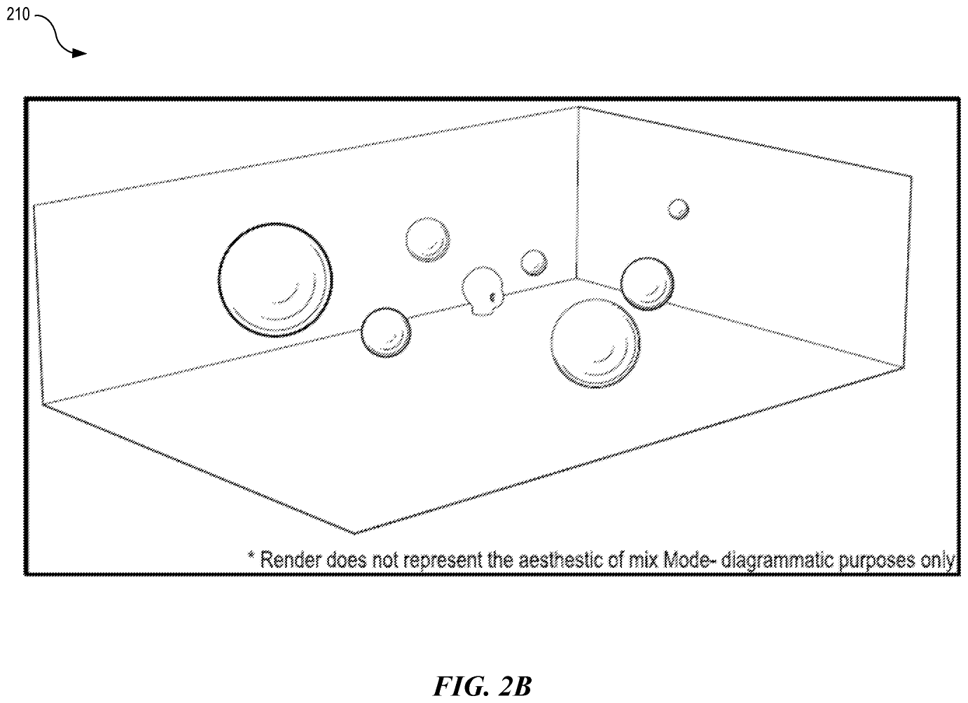

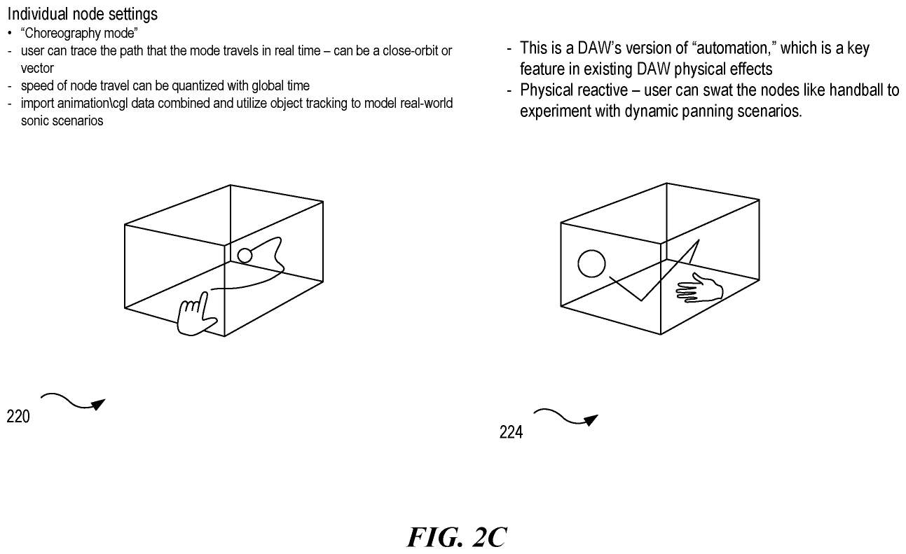

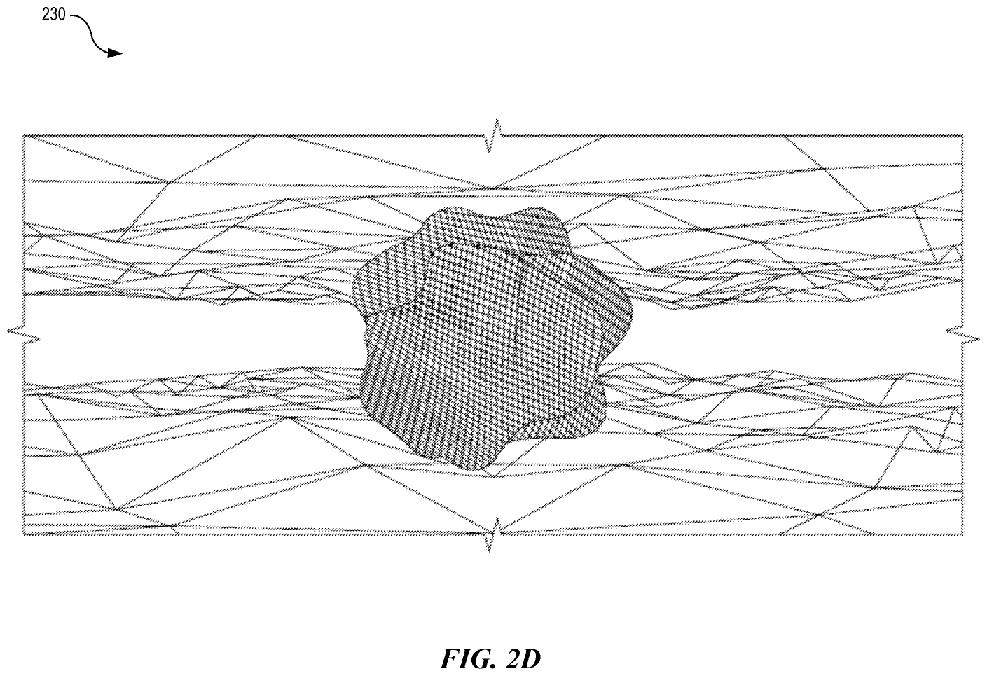

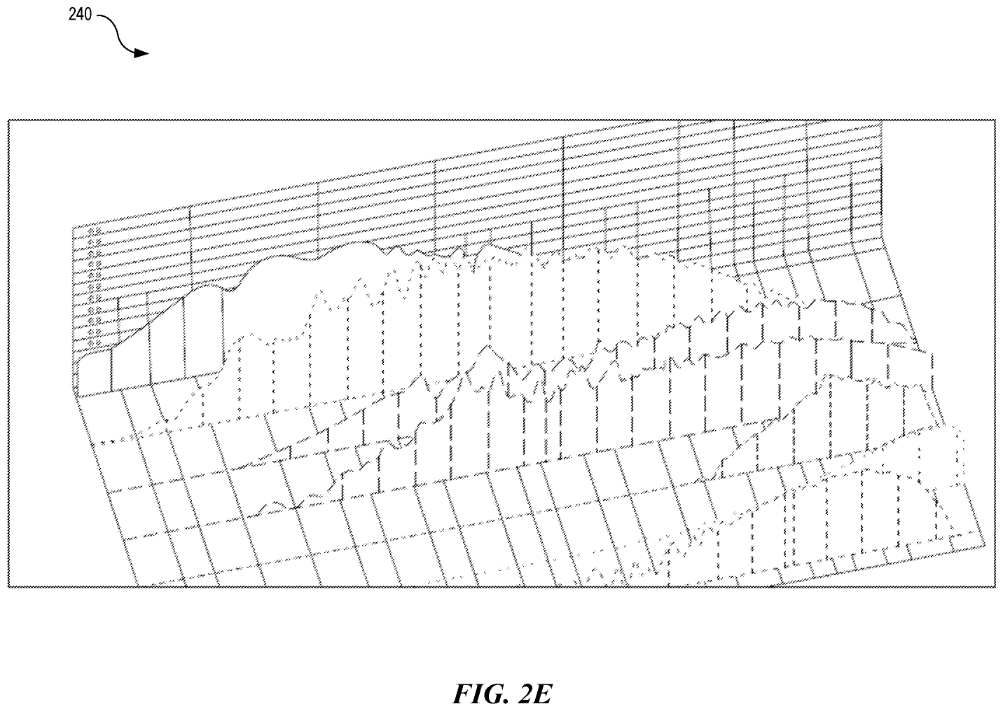

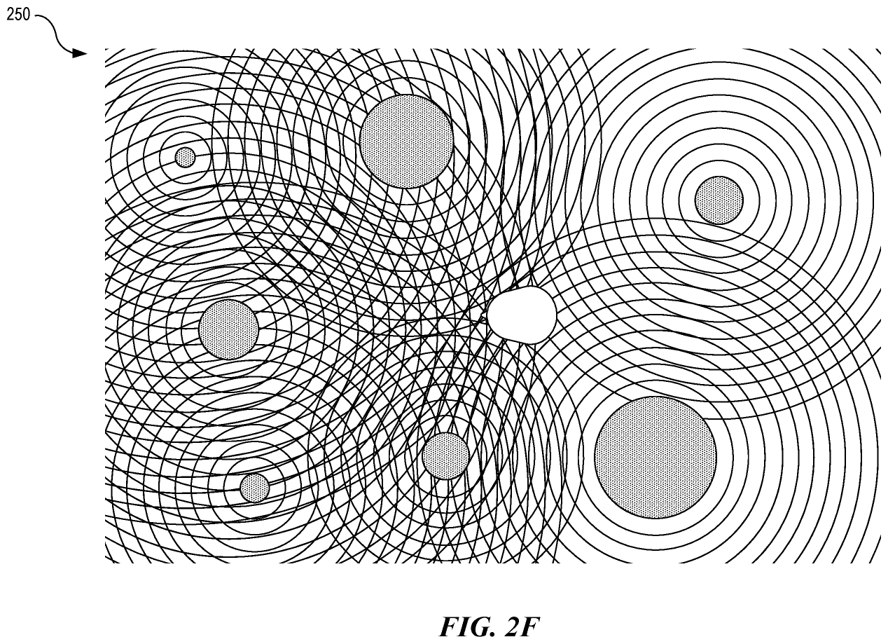

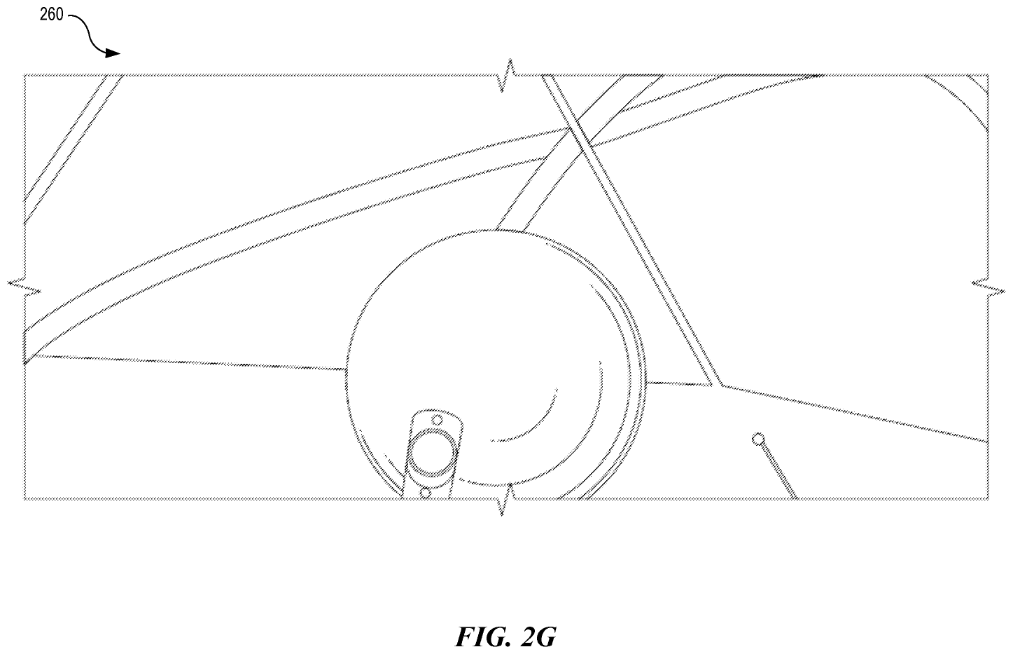

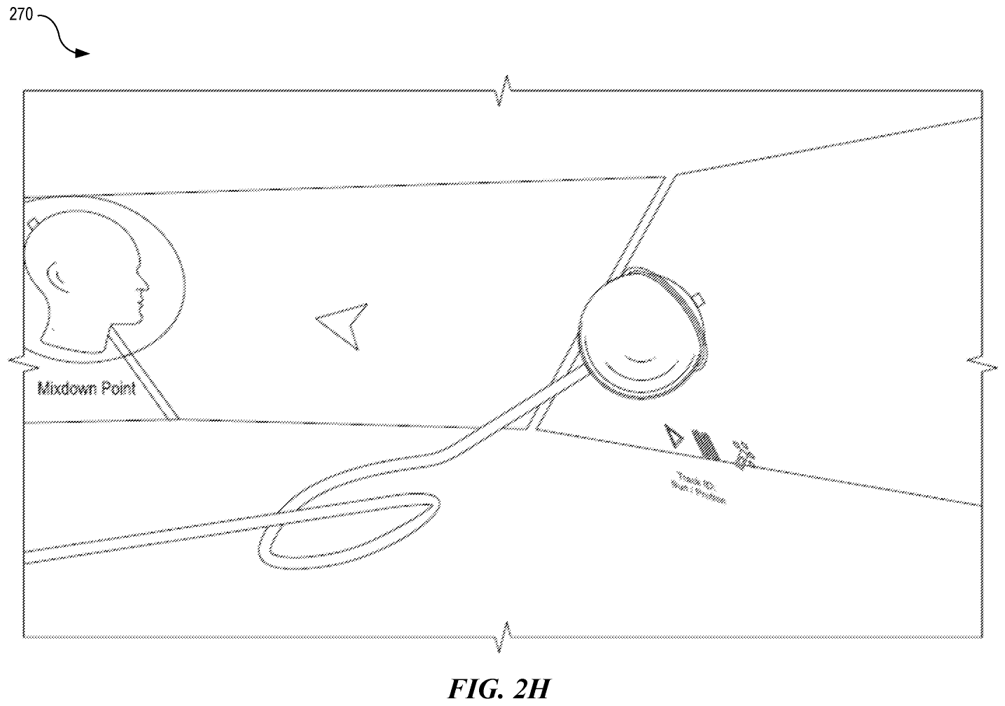

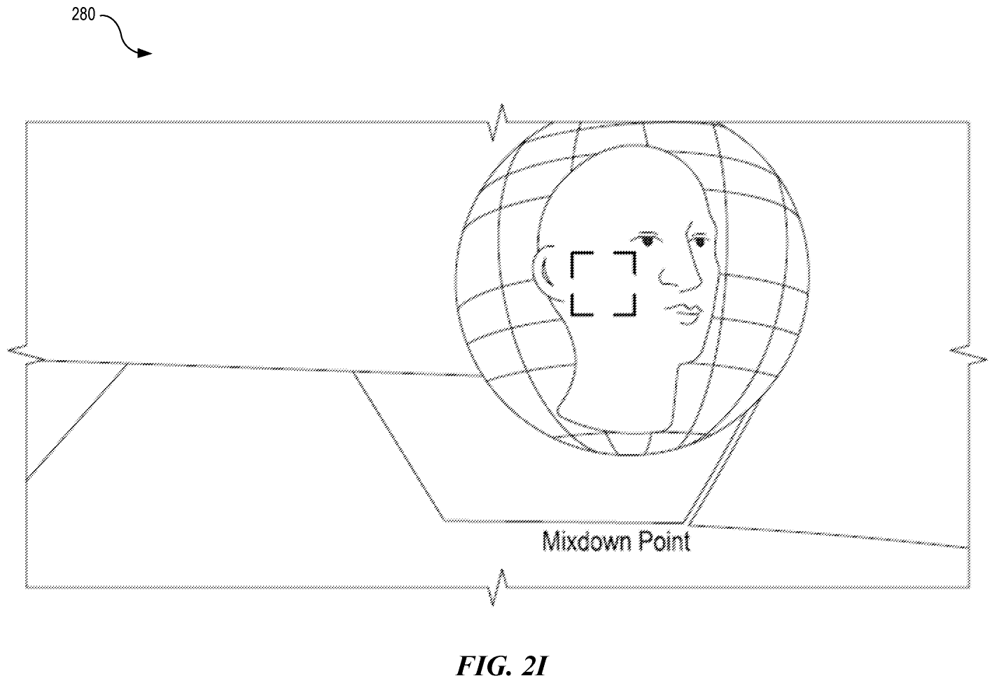

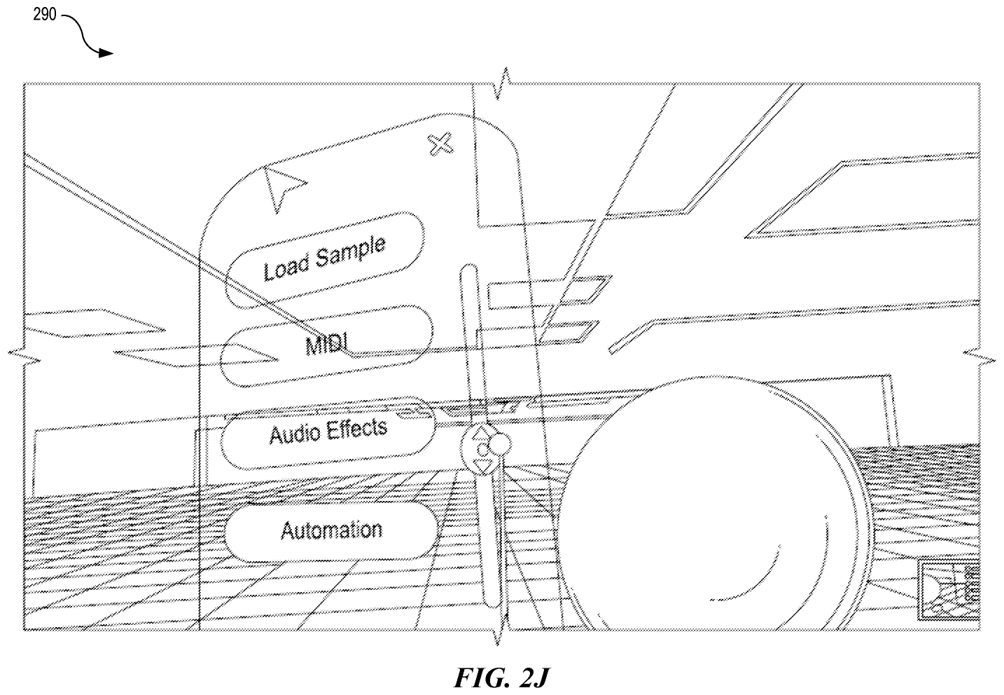

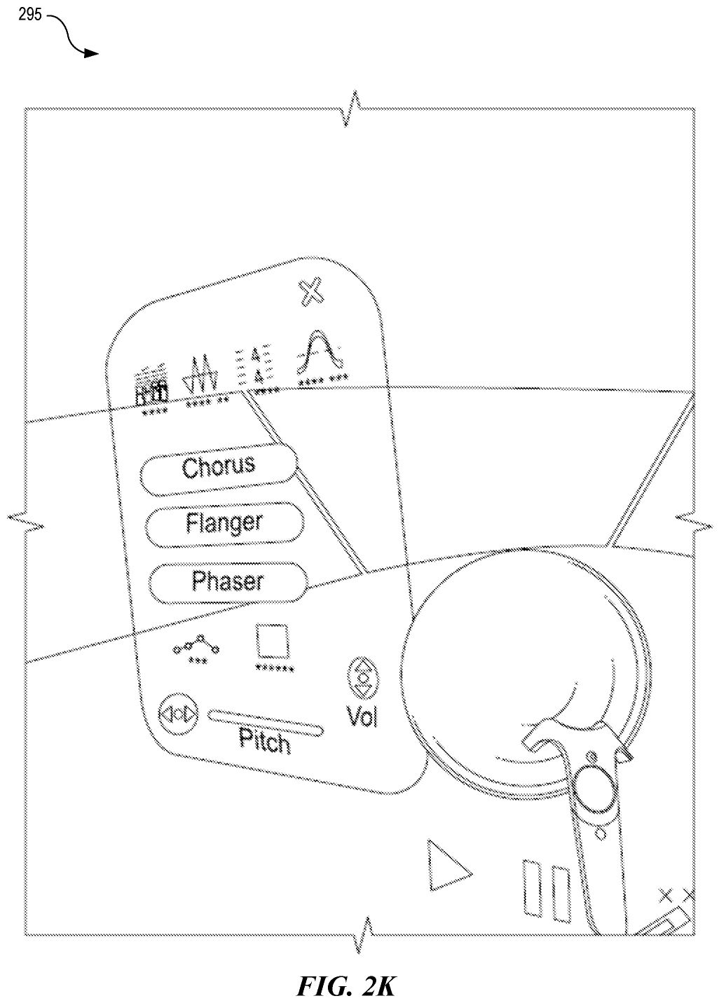

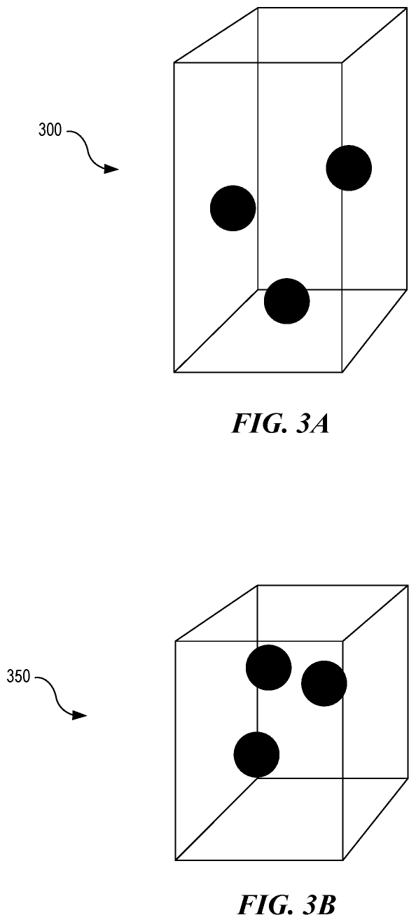

The mix mode is an audio mixing feature within the disclosed VR/AR enabled digital audio workstation (DAW). Based in an immersive virtual environment, the mix mode provides sophisticated audio mixing functionalities through the use of virtual 3D space, object-base mixing, gestural control and visual interaction. FIGS. 2A-2K and 3A-3B illustrate examples of digital representations of an audio track for implementing the mix mode.

According to some embodiments, tracks of a digital audio are represented as orbs/spheres (also referred to herein as “nodes”) in a mixing environment of a virtual studio. Advantageously, the disclosed technology allows a user to interact with the nodes displayed on an interface using gestural control. By embodying audio tracks as objects in a virtual space, the disclosed AR/VR enabled DAW enables users to mix audio in a hands-on manner by using intuitive movements such as moving, placing and manipulating such objects within a virtual space. For example, such movements can be for setting a track's volume and panning position. Thus, at least one patentable benefit of the disclosed DAW is that the disclosed DAW is based on the physics of relative audio positioning and perception, mimicking “realistic” behaviors of sound considering the spatial characteristics of the environment.

FIG. 2A shows an example point-of-view (POV) 200 in a virtual environment. The example POV 200 shows a mixdown point with 3 audio nodes surrounding the mixdown point. Each node (representing an audio track) are located at the center of the space defining a mixing environment. Initially, the nodes are identical in size (default volume level) and have identical physical and textural properties (i.e., with no effect modulators applied). The initial position can be regarded as the default position. From the default position, nodes can be manipulated in size and position. For example, nodes can be enlarged, shrunk, moved around, and/or selected for further actions (e.g., adding effects). Selecting a node can cause display of a pop-up menu with various actions to edit the audio track represented by the node. Examples actions can include adding delays, adding flangers/phases/chorus/vibrato, adding equalizers, compressing a track, adding reverberation effects, and the like. Each action can cause display of a user interface module with associated parameters.

FIG. 2B depicts a user's head as mixdown point surrounded by multiple nodes. The user's position in the mixing environment 210 is defined as the mixdown point, i.e., a position corresponding to a sum of the relative volume and positions of the nodes surrounding the user in the mixing environment. The position, volume, movement, and other mixing attributes of audio tracks is relative to the mixdown point in virtual 3D space. For example, the mixdown point can be considered to be equivalent to the sum/resultant of all mixing parameters in a conventional console or a DAW environment. In contrast to a conventional console or a DAW environment in which the mixdown is achieved through the setting of parameters on each specific track, the mixdown point in the disclosed VR/AR enabled workstation is determined computationally in 3D virtual space simply based on the user's relative position to all nodes (tracks) in the mixing environment. Thus, at least one benefit of the disclosed technology is that the location of the mixdown point can be incorporated as a parameter in mixing of audio tracks. The user embodies the mixdown from a first person perspective. A change in the user's position causes the location of the mixdown point to change. Further, in a conventional console or a DAW environment, changing the mixdown requires changing the volume and panning of every single track. However, advantageously, in the VR/AR enabled DAW, the user can change or alter the mixdown point without changing locations (e.g., place and changing position) of other nodes in the virtual mixing environment.

In some embodiments, the location of the mixdown point is set as default. In some embodiments, a user can move himself or herself, and thereby, the location of the mixdown point can change. For example, the disclosed VA/AR enabled DAW provides a diorama view, showing a zoomed-out view of the mixing environment positioned directly in front of the user's point-of-view. The location of the mixdown point can be changed in the diorama view. Upon selecting (via the user interface) a region of the mixing environment to place the mixdown point, the user can “re-spawn” the selected region, thereby seeing the mixing environment from the third person. The diorama view can enable a user to analyze the effect of the audio track at different locations within the mixing environment. A user can make gestures to move and place nodes within the environment, move and place the user's position, and alter the size or shape of the mixing environment itself. For example, a quick pick-up gesture can lift the user POV “mixdown point” from one end of a tunnel to the other. When returning to first-person POV, the user can find himself or herself at the other end of the tunnel.

FIG. 2C depicts example 220 and 224 of various manipulations performed on nodes. For example, a user's interaction with an audio node is similar to the manner a user would treat a handball. Placement of a node (from the perspective of the user's location or the mixdown point) in a mixing environment can be made by a user's gestures. Placing a node a certain distance away from the user's position not only affects the volume, but also affects the reverberation characteristics of the mixing environment. For example, a node placed the same distance from the user in a large cathedral and a bathroom is subjected to different reverberation effects because of differing acoustics of the large cathedral and the bathroom. Thus, placing a small node close to the user or a larger node further away can produce similar levels of sound amplitude (volume), however, the sonic quality will be different in each case due to different reverberation effects. Reverbs can be regarded as 3D virtual sub-environments (that can be integrated into a larger acoustical environment). Reverbs can be represented in the disclosed VR/AR enabled workstation as a library of impulse responses corresponding to real-world spaces. Thus, for example, there can be an impulse response for a cathedral environment, an impulse response for a long tunnel environment, an impulse response for a bathroom environment, an impulse response for a first concert hall such as Madison Square Garden, an impulse response for a second concert hall such as Carnegie Hall, and so on.

In some embodiments, the disclosed VR/AR enabled DAW allows a user to select from predefined acoustical environments (e.g., a large cathedral, a long tunnel, or bathroom). In some embodiments, the disclosed VR/AR enabled DAW allows a user to create an acoustical environment from a set of specifications such as shape, size, surface materials, reflective properties, and medium associated with the acoustical environment. The acoustical environment (predefined or user-created) can be used as an environment in which multiple audio tracks are mixed to generate a single audio track. In some embodiments, the disclosed AR/VR enabled DAW displays visualizations of sound waves interacting with the surface and space in the mixing environment. The user can see the sound emitted from each node, the manner in which the emitted sound travels through 3D space, and reflected/refracted off various surfaces in the mixing environment.

FIG. 2D depicts an example node 230 subjected to undulations based on rhythm and glowing with a certain color based on a frequency of the audio track. Thus, different tracks having different frequencies can be represented by different colored nodes on the user interface displayed to a user. A node transforms in shape, size and color to reflect the behavior of the audio track corresponding to the node. As a result of the visual changes or transformations of a node, a user is able to easily identity mixing opportunities in the audio track corresponding to the node. Manipulating the size of a node can modulate the volume of a track. Changing the position of the node relative to the user can change the track's spatial position in the mix. The node can glow a certain based on the frequencies contained within the mix. Tracks with dynamic frequency ranges can continuously change color accordingly. A node undergoes undulation according to the rhythmic elements of the track, and changes texture, shape, or other visual attributes based on effects modulators applied to the audio track. Nodes can be expanded or shrunk using gestural motions. The larger a node is, the louder the audio track can get. A larger node can get louder than a smaller node, everything else considered equal. The farther a node is from the user, the more distant/quiet the sound of the audio track appears. If a node is placed to the left of the user, it can be perceived in the left-hand side of the mix. If a node is set to circle around the user continuously, a 360-degree panning effect can be heard on that track. A node can be subjected to the natural reverb provided by the virtual acoustics of the virtual mixing environment.

In some embodiments, the disclosed VR/AR enabled DAW enables visualization of the dynamics of the audio track. For example, delays, choruses, and flangers are depicted as a specter/electron field on a node. A distortion is depicted as a rough surface on a node. Advantageously, visualizing these effects as physical characteristics of a node that the user can see and interact can promote enhanced user experience.

For example, disclosed embodiments advantageously provide the option of a variety of delay effects that can be assigned to an audio track either via the mix mode (assign to node through pop-up menu) or via the arrangement mode. Delays may include ping-pong delay, tape echo, or bpm-based delays. Upon applying a delay effect to a node, a specter associated with the node can undulate in time according to the delay setting.

For example, disclosed embodiments advantageously provide the option of adding flangers/phases/chorus/vibrato to an audio track. Upon applying flangers/phases/chorus/vibrato effects to a node, a specter associated with the node can blur and morph in time with the effects setting.

FIG. 2E displays a three-dimensional (3D) equalizer 240 that allows simultaneous visualization and equalization of multiple tracks in 3D space. Disclosed embodiments provide a user an option to equalize a single audio track (represented by a single node) or a group of tracks (represented by a group of nodes) by selecting an equalizer from a drop-down menu and entering an interactive “EQ Field” in 3D virtual space. The user can “wander” around the EQ field and see a visualization of the frequency spectrum in real-time as the track is playing. A user can choose to selectively attenuate or amplify specific frequencies using hand gestures applied directly to the frequency spectrum. In parallel to the frequency spectrum of the track being modulated, the user can see the frequency spectrums of the other tracks in the mix. Further, the user can attenuate/amplify specific frequencies associated with the other tracks in the mix. This allows the user to visualize the full “equalization picture” (i.e., where the various tracks in the mix fit together on the equalizer band) of the mix, and further identify frequencies where multiple audio tracks overlap. The user is also provided the option to alter specific frequencies using hand gestures.

FIG. 2F displays example 250 of the effect of placing multiple nodes with respect to a user. In some embodiments, multiple nodes can be grouped to exhibit the same behaviors, have the same effects modulators and parameters, and follow the same automation path. For example, the user can group a node corresponding to a guitar track with a node corresponding to a bass track and apply the same effect or the same automation curve to the two nodes.

FIG. 2G displays an example 260 of a trajectory of an audio node. For example, the trajectory of an audio node can be beneficial for tracing an audio node in virtual 3D space as the audio node moves throughout the virtual 3D space. Tracing an audio node can be used for panning and positioning of an audio track. Nodes can be programmed to move either by carrying/throwing/placing a node and recording its movement, or by drawing a trajectory in free-form or through a variety of pre-set vectors. For example, a node can be programmed to move in a circle around the user, producing an effect of 360-degree panning. The user simply can draw a circular “track” around himself or herself, and as a result, the node rotates at a set speed, producing a 360-degree panning effect as the node moves around the user's position. FIG. 2H displays an example 270 of a trajectory of an audio node illustrating mixing node automation. FIG. 2I displays an example 280 of a mixdown point displayed on a GUI. FIG. 2J displays an example 290 of a mixing node menu displayed on a GUI. FIG. 2K displays an example 295 of a mixing node menu displayed on a GUI.

FIGS. 3A-3B shows a pictorial representation of a node's waveform visualized within a box 300 and 350. A limiter/compressor is visualized as a bounding box placed around a node. By altering the dimensions of the box, a user can compress the track. Thus, the dimensions of the box are illustrative of specific compression settings. A user can place multiple nodes/tracks in the same box to visualize how each track is compressed by applying the same compression settings. Alternately, a user can apply different compression settings for different nodes/tracks by using overlapping boxes. The tightness of the box is indicative of the amount of compression of a track. The more a track is compressed, the box housing the node gets tighter. For highly compressed tracks, the user will see the node “squashed” within the box, which facilitates an intuitive visualization of compression.

### Collaborate Mode

Collaborate Mode is the collaborative function within the disclosed VR/AR enabled digital audio workstation in which users can interact and collaborate (in real time) on a project within a virtual 3D environment. The disclosed collaborate mode can provide the experience of a connected musical eco-system to artists/producers who are often unable to be physically present at the same location. Further, the disclosed collaborate mode can be used to create a library of interactive tutorials in which users can enter real projects and learn hands-on from either an AI-powered “user”, or a real human user in real time. Advantageously, collaborations in the disclosed VR/AR enabled digital audio workstation can occur irrespective of the user's platform (e.g., VR headset, mobile device, wearable computing device, laptop computer, VR/AR goggles etc.). For example, user in different locations can simultaneously work on a project—i.e., arrange, record, play, mix, modulate, etc.—while seeing and interacting with each other as avatars within a virtual 3D environment. This is in contrast to collaboration in conventional DAWs in which a collaborator is limited to viewing only the cursor of another collaborator, with no way of tracking each other's work throughout the project.

When invited to collaborate, a user receives a link from another user to enter a project (e.g., a virtual 3D environment hosted by the disclosed AR/VR enabled DAW). The collaborator(s) can appear in the virtual environment as an avatar. Users can navigate the space together, communicate with one another via a chat box or via voice, and work/collaborate on the project (e.g., creating an audio mix). For example, one user might be in the virtual environment placing nodes (e.g., representing audio tracks in a mix) to dial in the mix, while another user can be changing parameters of a delay effect module activated on a specific node. The communication between/among users can be enabled by the disclosed AR/VR enabled DAW, or alternatively, a third party application software such as Discord. A user can join via the virtual environment using a VR headset or AR mobile device. Users may also join via PC through a 360-degree website as an observer.

### Arrangement Mode

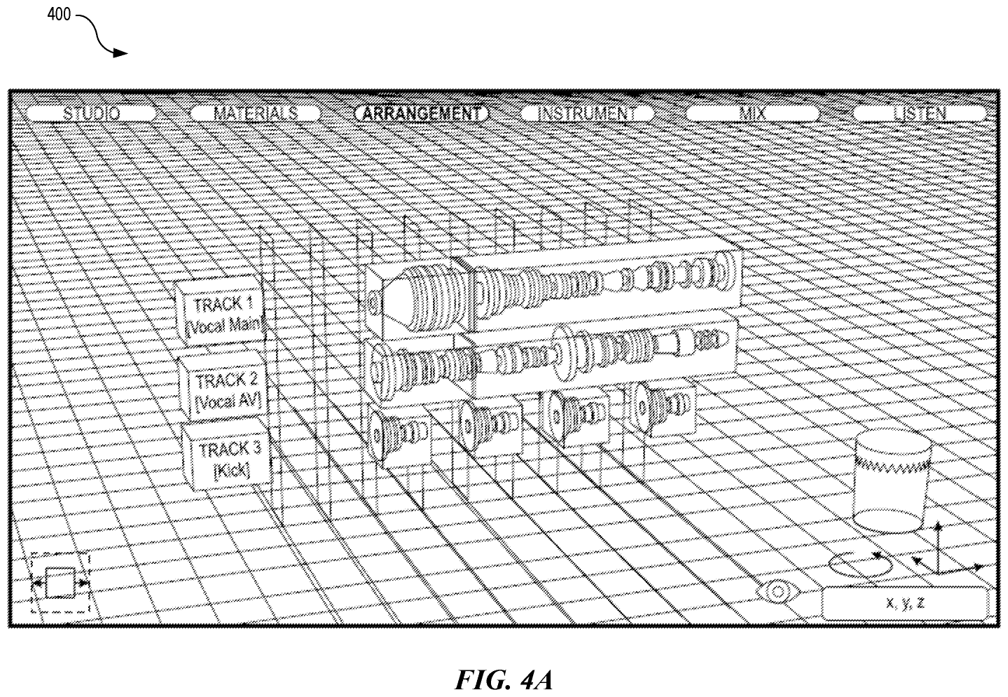

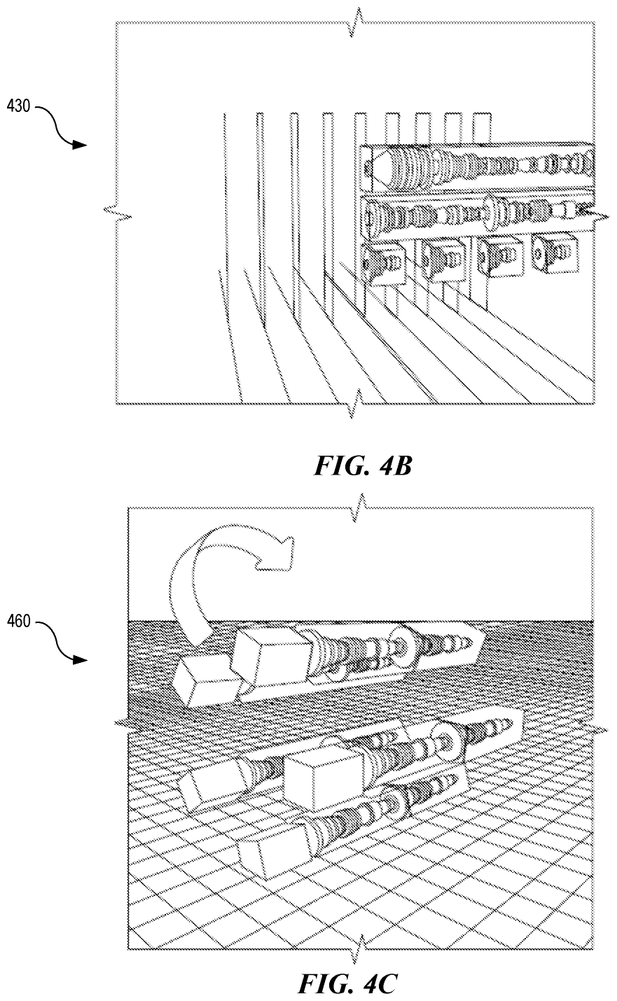

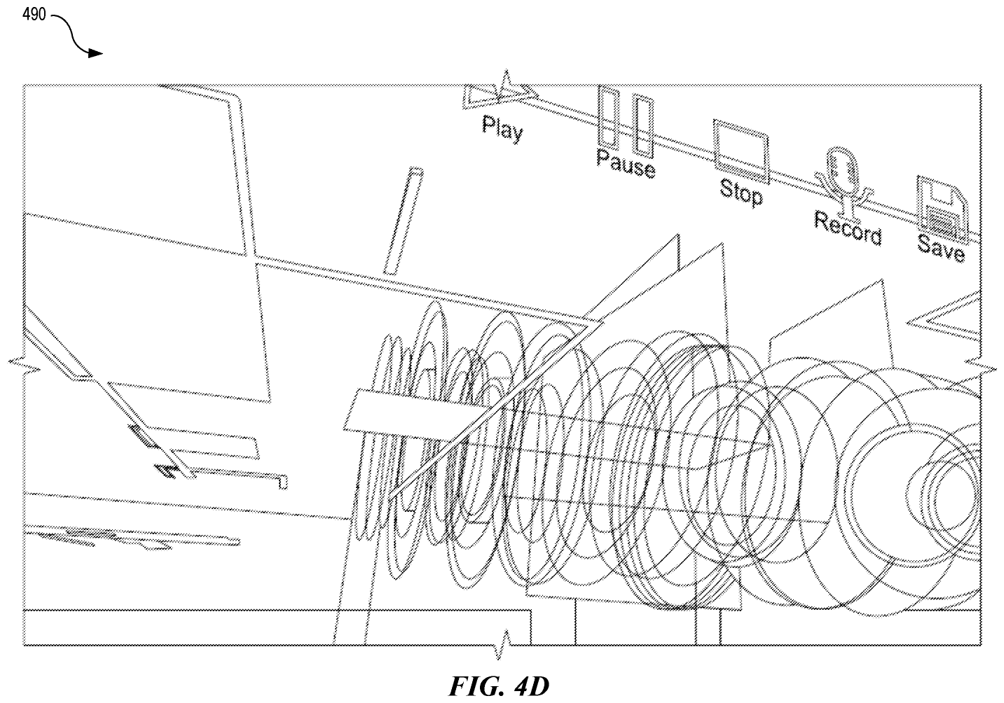

The arrangement mode is a functionality within the disclosed AR/VR enabled DAW which allows users to arrange elements of a production, such as loops, tracks, recordings and clips in chronological order to form a musical composition. FIGS. 4A-4D show pictorial representations of blocks of audio tracks in connection with implementing the arrangement mode. Advantageously, the arrangement mode offers the enhanced experience of an immersive 3D virtual environment in which the user can interact with, edit and arrange elements of a composition using gestures. For example, based on a chronological display enabled by the disclosed DAW, users can view, edit, and interact with tracks. The tracks can be imported into the disclosed DAW from an external source or generated within the disclosed DAW. The chronological display, for example, can help users with creating a narrative associated with a production. Pre-imported and pre-generated tracks, clips, loops and samples can be grabbed and inserted into an arrangement. One or more gestures will allow a user to move a track or clip along the sequence, extend it via looping, cut a track into one or more shorter sections, as well as perform other standard arrangement editing functionalities (e.g., select, cut, copy, paste, delete, etc.).

FIG. 4A shows an illustrative diagram 400 of a track block interface. A track block interface is a collection of chronologically-displayed tracks of an audio. The chronologically-displayed tracks in the 3D space can be in the form of 3D rectangular blocks that can be created, deleted, moved and edited gesturally using the user's hands or controller. Track Blocks represent clips that were either imported into the disclosed VR/AR enabled DAW or generated using the disclosed VR/AR enabled DAW. Imported and generated tracks can be stored either in easily accessible folders within the menu system, or anywhere within reach in the virtual studio environment, ready to be deployed by the user at any time. For example, the user can view the arrangement in the form of a stack of horizontal track blocks displayed on a user interface. When a composition (e.g., represented as an arrangement of track blocks) is “playing”, track blocks can be observed by the user as passing through a static playhead (e.g., diagram 430 as shown in FIG. 4B) directly in front of the user. The playhead represents the exact point in time—a line cutting right through the stack of track blocks—being played in the arrangement. While the playhead remains static, the tracks can be perceived as passing through the playhead from right to left, as the tracks progress forward in time. Users can gesturally swipe a track block left or right to focus on a specific time point in the composition. The 3D space allows for a more open and customizable palette for users to work with—a pallet of clips, recordings, samples, loops, but also effects modules as well as alternative views. For example, in some embodiments, tracks can be arranged on the user interface vertically rather than horizontally. In some embodiments, the arrangement mode allows 3D rotation (e.g., diagram 460 as shown in FIG. 4C) of track blocks for editing purposes. FIG. 4D shows example 490 various choices available to a user in connection with editing a track block.

As a use-case example, a user may want to select a 1-bar portion of a drum track that is loaded onto a track block. The user can either drag his/her hand to select the clip (e.g., smart selection and quantization grid can select a perfect bar), or the user can chop twice—once at the beginning of the bar, and once at the end, to isolate the clip. The user has a variety of editing options with that clip. He/she can simply delete or move the clip in the 3D space. Alternately, he/she can extend the loop of that clip by dragging out the edge of the clip. Alternately, he/she can double-tap the clip to enter a sample editor to perform a variety of modulations on the clip such as reversing, chopping up, pitching up or down, and applying oscillators or envelopes. Alternative functions of double-tapping a track block selection include selecting an effect from a variety of effects modules included in the disclosed VR/AR enabled DAW. The effect modules can be located behind the user or on the user's side. The user can arrange various modules in arrangement mode according to his/her preferred workflow. This customizable and 3D interface, in which objects and modules surround the user, allow the user to quickly and intuitively work between the arrangement and the effects/modulators, or even manipulate both at the same time. In some embodiments, the arrangement mode of the disclosed AR/VR enabled workstation allows 3D rotation of track blocks for editing purposes. In some embodiments, the arrangement mode of the disclosed AR/VR enabled workstation allows triggering a sample with one hand of a user while modulating the affect applied to the sample with the other hand of the user, thereby facilitating parallel processing operations within a computer environment.

The fully customizable, virtual 3D environment within the arrangement mode leverages virtual space as an organizational tool for effective file management. Instead of storing loops, samples, sounds, and effects presets in folders accessible through menu-diving, users can “keep” these objects and modules in the virtual studio environment that can not only be accessed at any time, but identified, recognized and reached at any time. For example, a user can turn around, pick up a drum loop they had been “saving,” and pop the drum loop into the arrangement without a break in creative flow. The storing of various potential elements of a composition is more visual and accessible. For example, a user may have one or more pre-generated or imported track blocks whose location within the composition may have not yet been determined. Those track blocks can simply be stored in the virtual environment as a stack, ready to be picked up and placed at any time into a composition. This is advantageous over implementations in a typical DAW environment which involve tedious pointing and clicking, opening and closing of windows for editing clips.

### Studio Mode

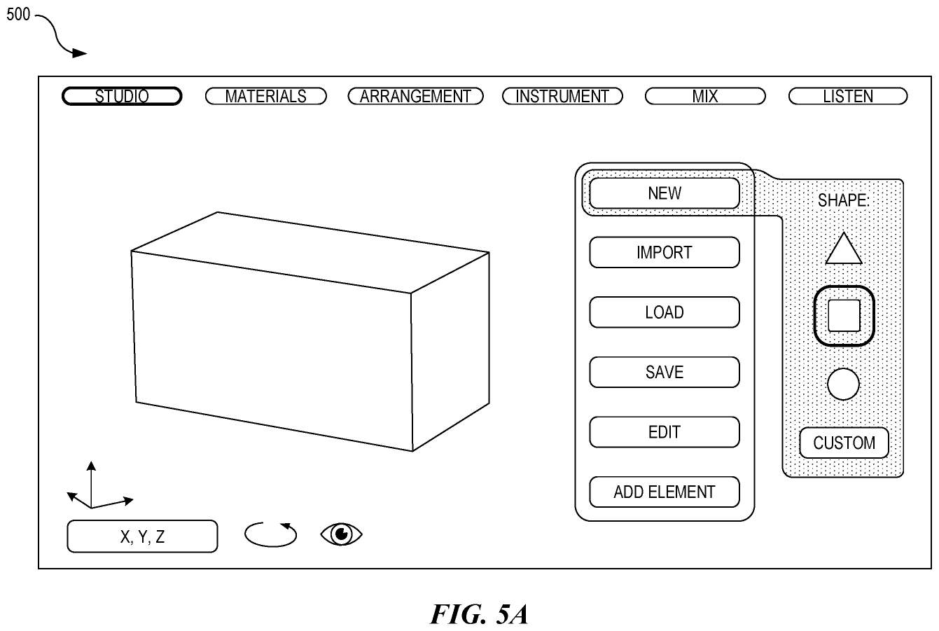

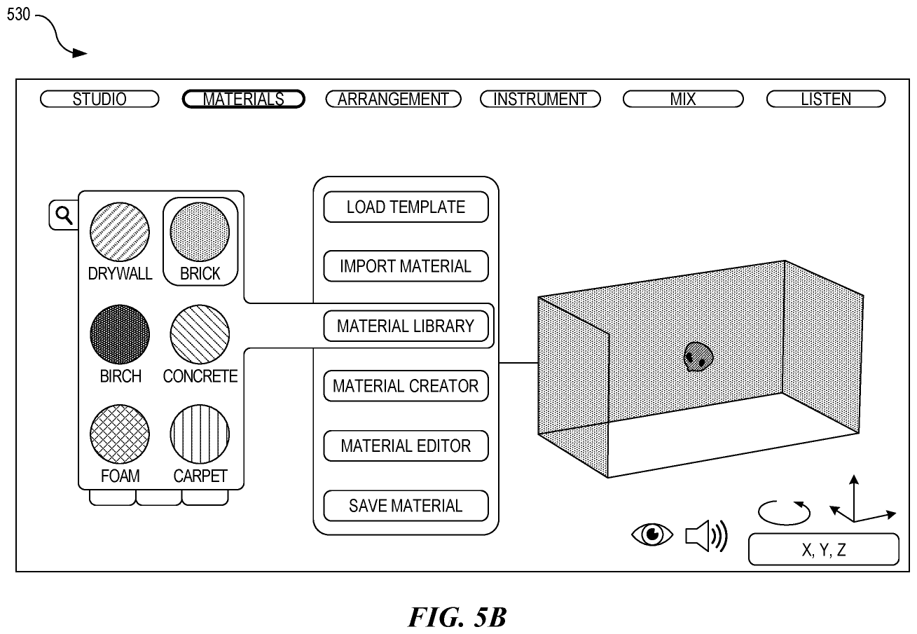

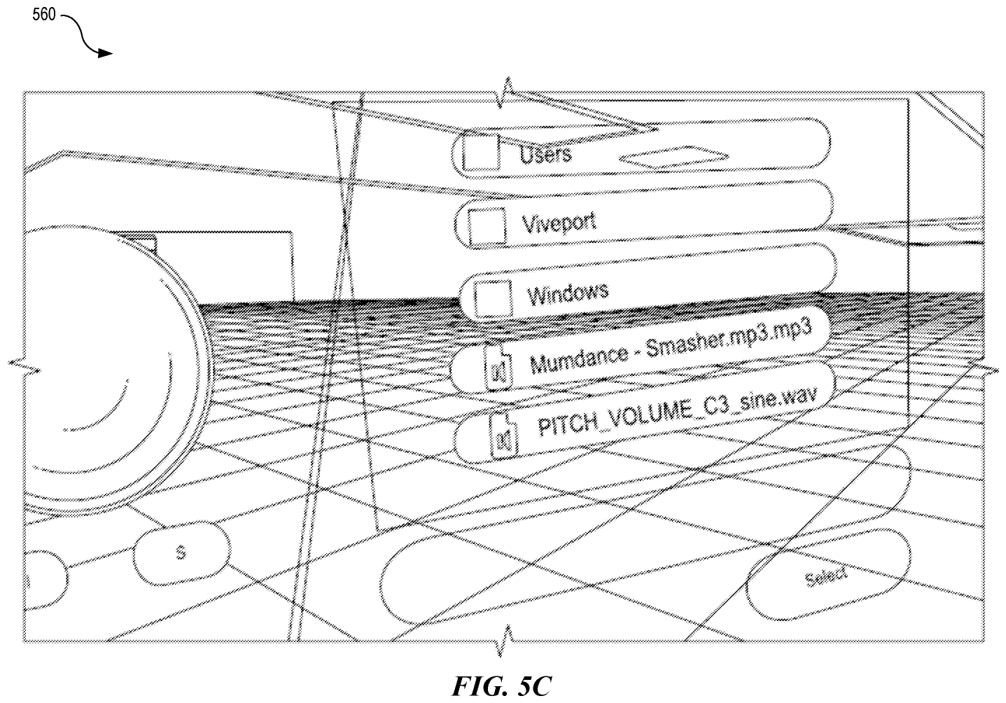

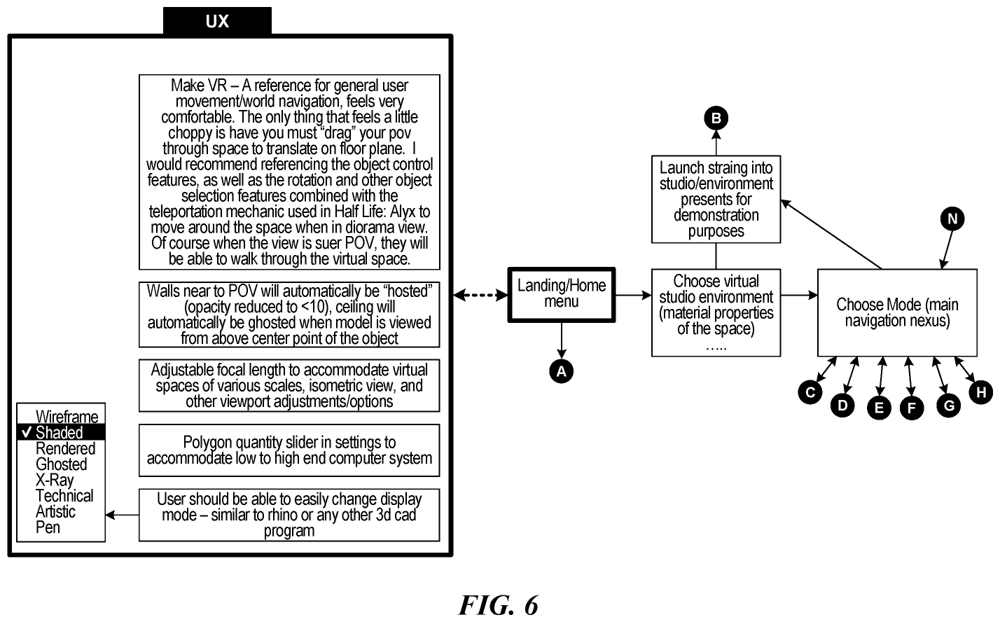

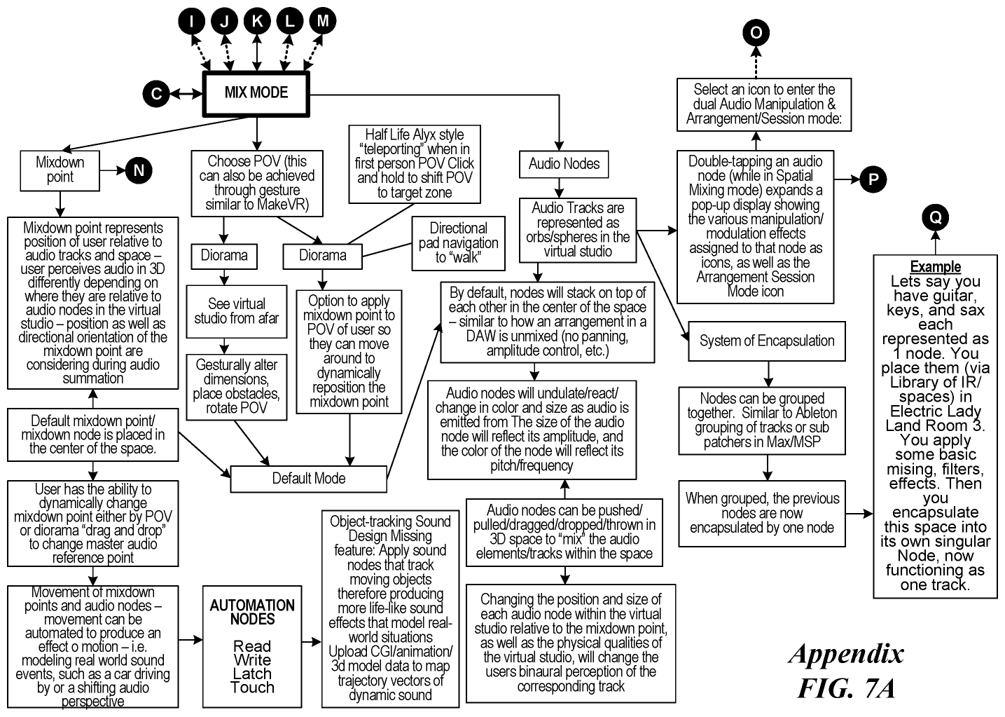

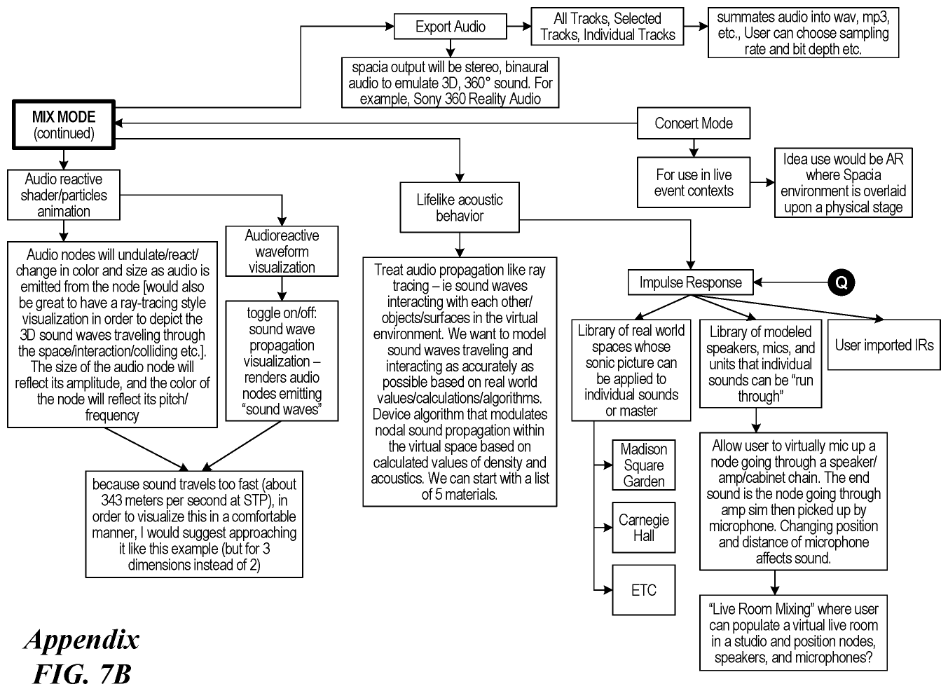

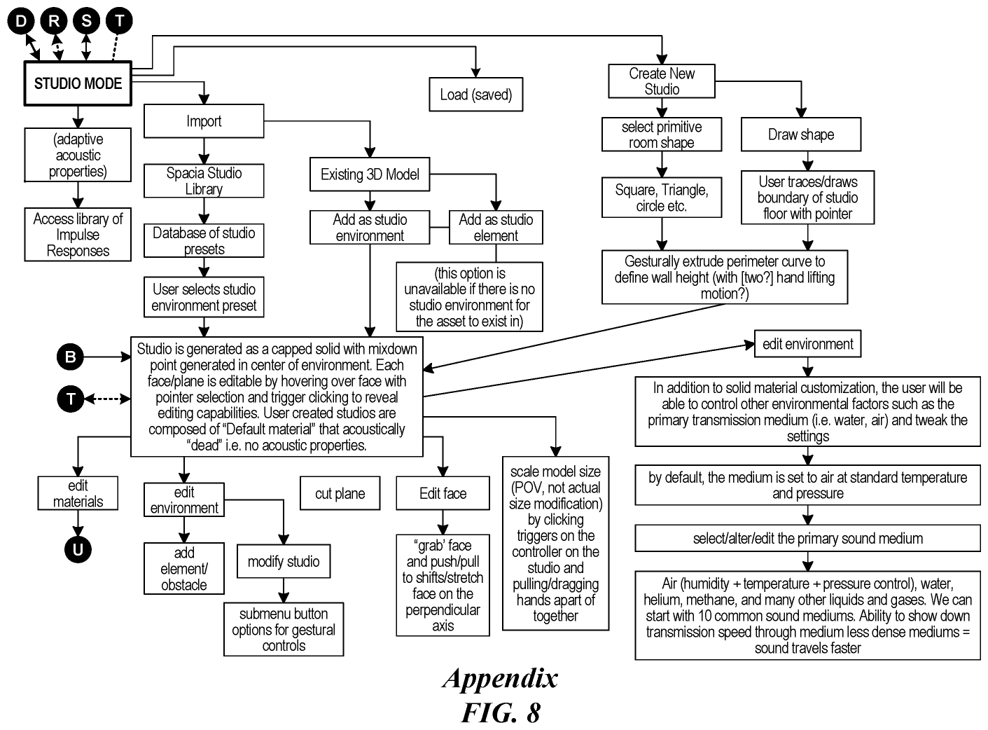

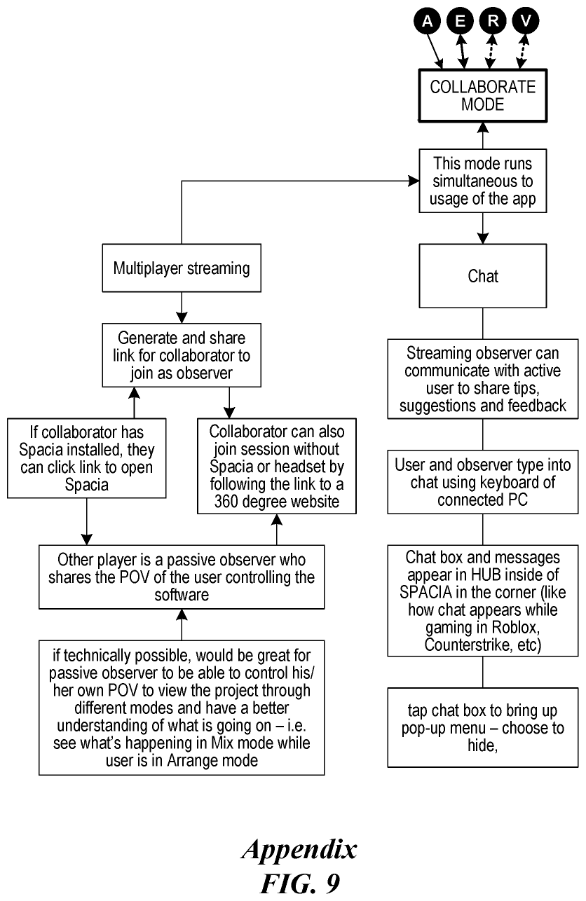

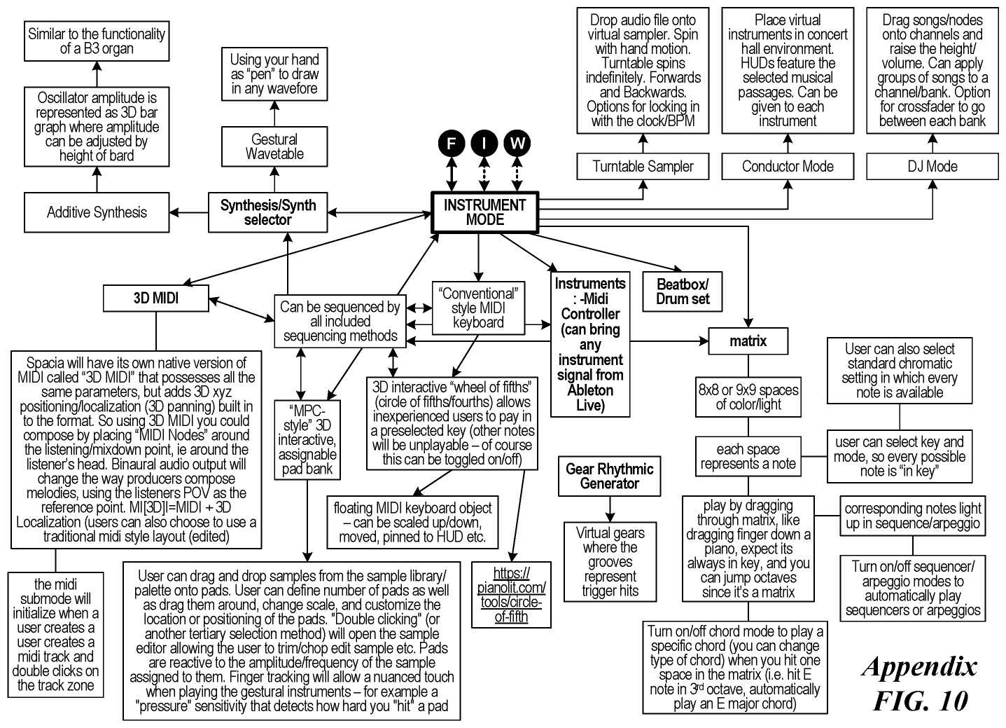

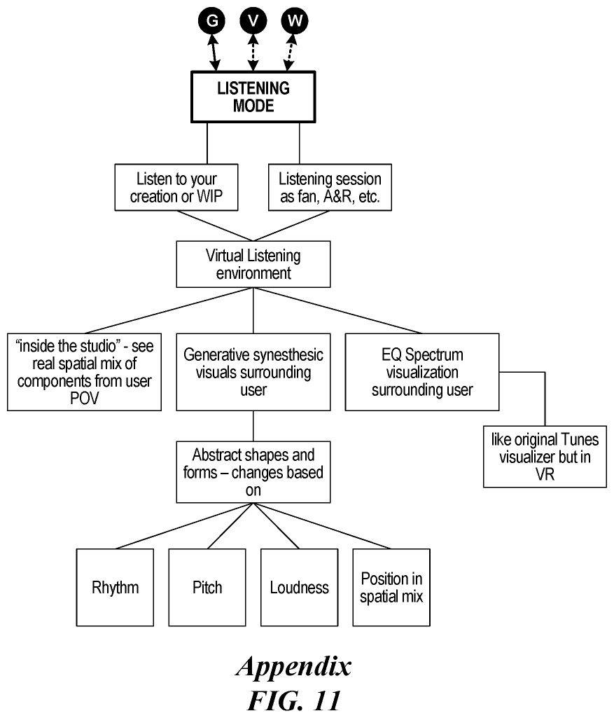

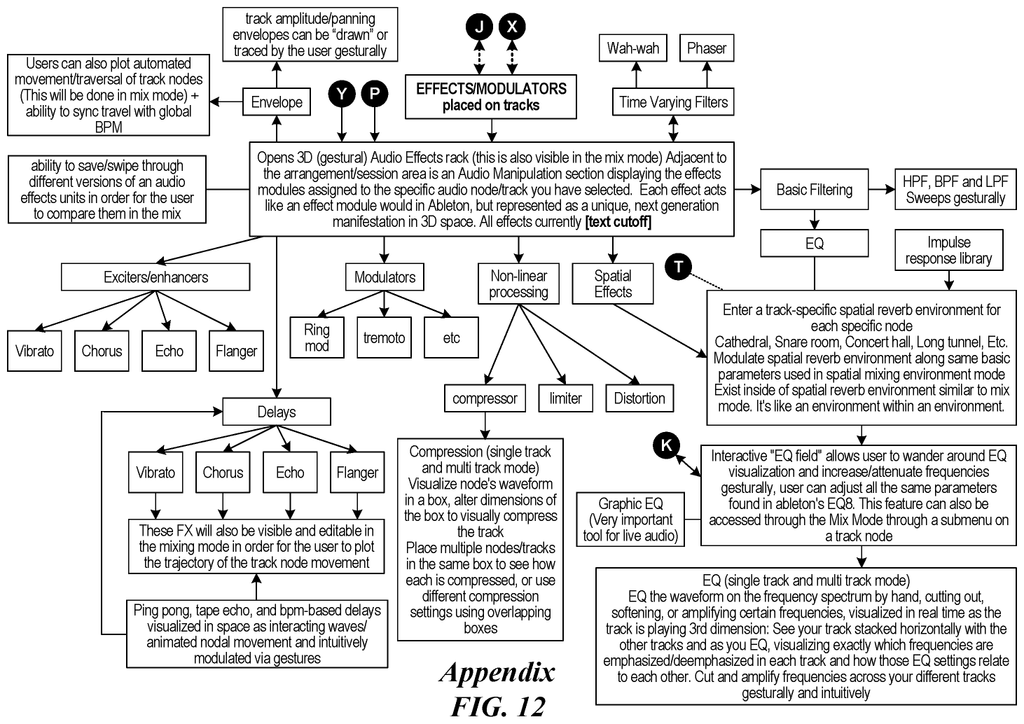

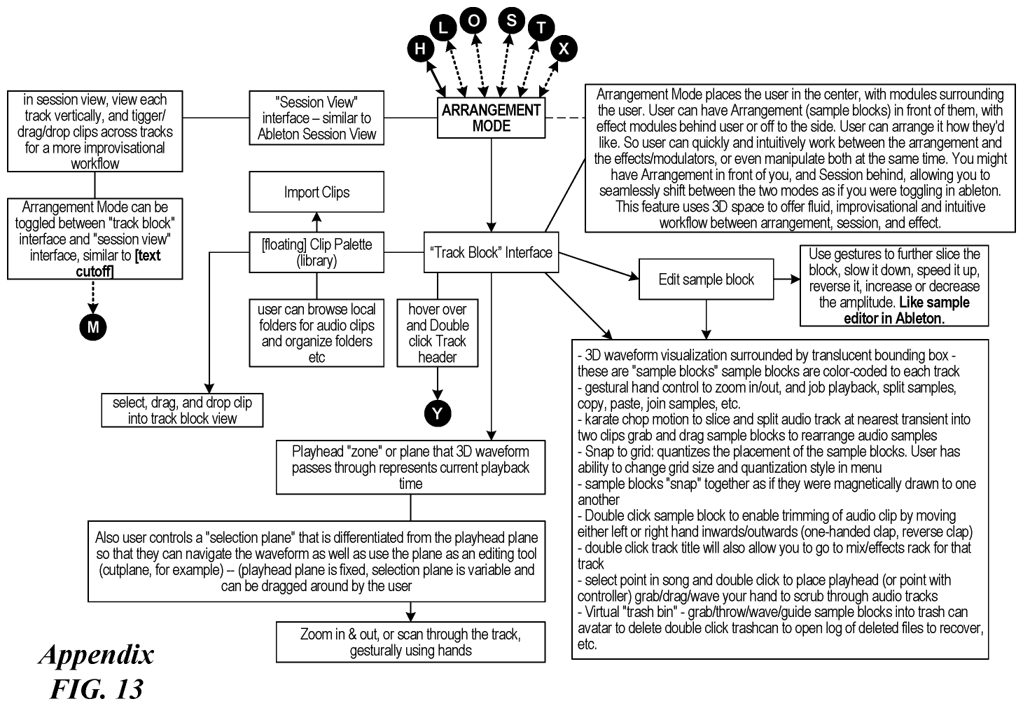

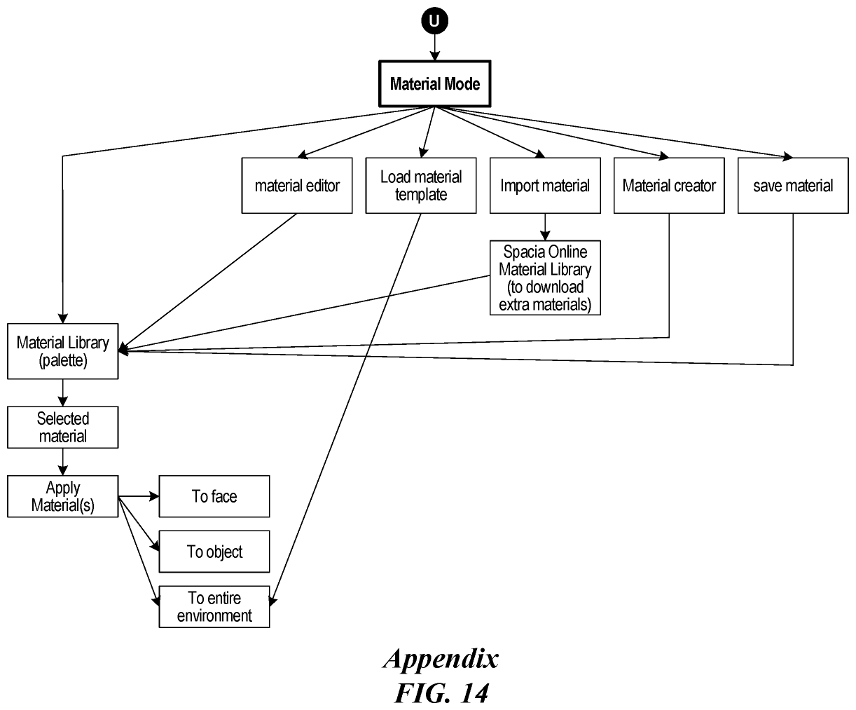

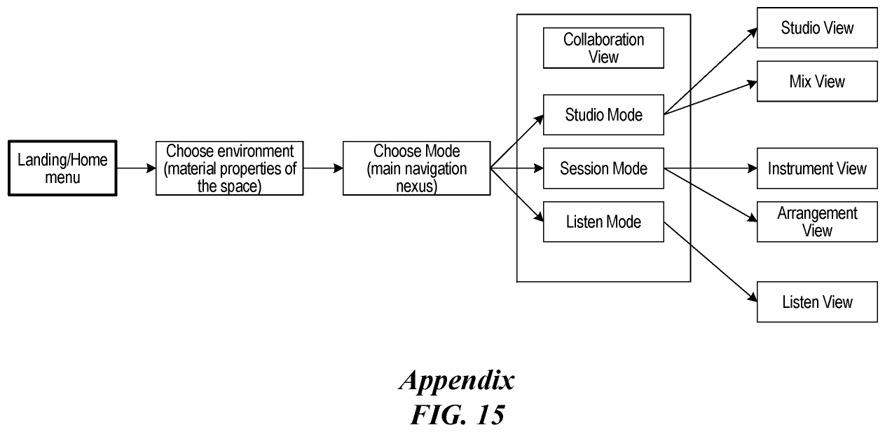

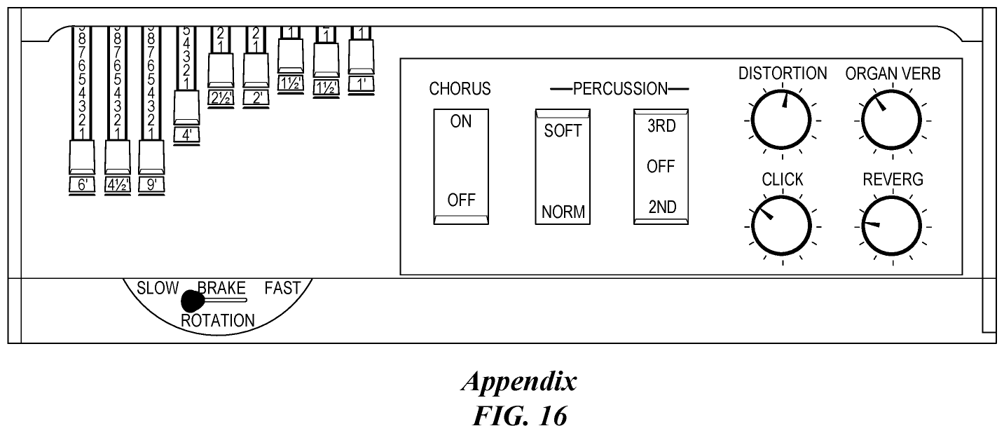

Studio Mode is the functionality within the disclosed AR/VR DAW in which users can create a virtual mixing environment (VME) (alternatively termed herein as virtual 3D space). The VME is the result of a computer simulation of a physical space for the purpose of audio production and mixing. Typically, a VME is created (e.g., based on one or more physical and acoustical characteristics that the user can adjust) and subsequently imported into the mix mode. In some embodiments, a VME is based on a combined modeling of impulse response of an environment (such as Carnegie hall) and modeling of surface/medium/shape/dimension reverberation in the environment. The acoustical properties of the VME can directly impact the way sounds are perceived by the user. In some embodiments, the VME can include customizations (based on acoustical properties) for influencing the spatial characteristics of various audio tracks included in an audio mix. Acoustical properties (e.g., as shown in example 500 of FIG. 5A and example 530 of FIG. 5B) can be related to specific spaces shapes/dimensions/surfaces/objects, types of materials, etc. Examples of an environment can include well-known music studios, recording environments, public spaces, stadiums, concert halls, and unique/iconic structures. In some embodiments, the disclosed AR/VR enabled DAW provides a library of impulse responses corresponding to real-world spaces. Thus, for example, there can be an impulse response for a cathedral environment, an impulse response for a long tunnel environment, an impulse response for a bathroom environment, an impulse response for a first concert hall such as Madison Square Garden, an impulse response for a second concert hall such as Carnegie Hall, and so on. Additionally, in some embodiments, the disclosed AR/VR enabled DAW provides impulse responses simulating the tone of various well-known guitar and bass amps. In some embodiments, the studio mode can include one or more of import, create, edit, and ray tracing aspects.

### Import

Users begin by choosing to either create a VME from scratch or import a VME into the disclosed VR/AR enabled DAW. In some embodiments, the disclosed VR/AR enabled DAW can include pre-loaded VMEs such as a cathedral with the same spacious, reverberative quality as a real cathedral. In this case, users would select the preset cathedral VME and enter the VME corresponding to the cathedral and place audio tracks (i.e., nodes) in the VME. Audio tracks placed inside the cathedral will be perceived by the user with the same acoustical properties as if those tracks were placed in the same locations of a real cathedral. For example, after placing the drum track node in the back of the cathedral, a user located in front of the altar will perceive the drums as distant with a long, diffusive reverb. Users can also select from a variety of more “practical” imported VMEs, such as the recording rooms of Abbey Road, Electric Lady Studios, 30th Street Studios or Gold Star Studios. These famous studios were long used for their unique sonic characteristics and the VMEs corresponding to these recording rooms provide the same simulated acoustical qualities as the real world recording rooms. Users can load imported VMEs corresponding to other environments such as a New York Subway tunnel, the bottom of the ocean, or a studio made entirely of ice. Users may also load existing 3D models and convert them into VMEs. For example, a user can generate a model of a 16×16 concrete room in a separate CAD software, import the model of the concrete room into the VR/AR enabled DAW. For example, FIG. 5C shows example 560 of a menu displayed on a GUI in connection with importing audio into a node.

In some embodiments, the VR/AR enabled DAW converts the model into a VME which can be stored digitally in a library. Users may also import 3D assets that can be converted into objects for integration into a VME. For example, a user can import one or more objects into a VME. In a hypothetical example, if a VME corresponds to the Abbey Road Studios recording room and an object corresponds to a mattress, upon integrating the mattress into the VME, the resulting sound will have the same absorbent effect that a real mattress placed in the Abbey Road Studios recording room would have.

### Create

Users can also create a VME from scratch. Starting with the shape of the environment, users can either draw using the draw tool, or select from a menu of predefined room shapes such as square, circular, rectangular, etc. In the process of creating the VME, the disclosed VR/AR enabled DAW displays the VME as a 3D “hologram” in front of the user. In some embodiments, the disclosed VR/AR enabled DAW can be configured to allow the user to toggle into a first-person view to test and navigate the space as the VME gets created. After selecting a room shape, the user gesturally extrudes the perimeter curve to define wall height with a hand lifting motion. The 3D model of the VME (e.g., represented as an object) can be edited to change dimensions. By pinching the corners of the VME, the user can expand and shrink various dimensions of the VME. The mixdown point is typically shown in the center of the VME and the user can “embody” the mix-down point from the first-person POV. Once the basic parameters of the VME are set, the user can customize any surface (floor, walls, and/or ceiling) for influencing the virtual acoustical qualities of the VME.

### Edit

After the dimensions of the VME are determined, the acoustical properties of the VME can be altered. For example, the user can hover over any surface of the VME by pointing his/her finger or a controller and choose from a menu of available materials to customize the acoustical properties of the surface. Available materials can include wood, concrete, foam, glass, gold, other metals, rock, fabric, and others. Each material is programmed to impart the realistic acoustical properties of the material. In some embodiments, users can mix and match materials of different surfaces. A first surface of the VME can be customized using a first material and a second surface of the VME can be customized using a second material. The resulting sum of different reflective and refractive properties of each surface and their material composition, angle, size and distance from one another creates the perceived sound. Users can further customize the VME by editing environmental factors such as the primary transmission medium, e.g., simulating the acoustical properties of the sound traveling through a different gas such as helium, or through water. The denser the medium, the slower the sound emitted from a node travels.

### Ray Tracing

While creating/editing the VME in studio mode, the user can enter the VME to test its acoustical properties. A default mixdown point and set of test nodes are displayed on the user interface. The user can hear the result of tweaks on the space's dimensions, surfaces, objects/obstacles, and transmission mediums on the test nodes. Beyond the auditory test of hearing differences in acoustics, the user can also see these differences through a phenomenon termed ray tracing. Ray tracing depicts the movements of sound emitted from nodes as linear rays as they reflect and refract from various surfaces and objects in the space. Users can visualize the movement of sound and see how this changes as they tweak the properties of the VME. Waves reflect and refract off of various surfaces and objects differently based on the materials used, as well as the frequencies being produced by the node of origin. The distance between surfaces, and between the nodes and the mixdown point, also dictates the disintegration of the sound; waves reflecting off of a faraway surface will be visualized as diminishing or disintegrating on their way to their next surface/object or the mixdown point, as depicted in the ray tracing.

Some of the embodiments described herein are described in the general context of methods or processes, which may be implemented in one embodiment by a computer program product, embodied in a computer-readable medium, including computer-executable instructions, such as program code, and executed by computers in networked environments. A computer-readable medium may include removable and non-removable storage devices including, but not limited to, Read-Only Memory (ROM), Random Access Memory (RAM), compact discs (CDs), digital versatile discs (DVD), etc. Therefore, the computer-readable media may include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments may be implemented as devices or modules using hardware circuits, software, or combinations thereof. For example, a hardware circuit implementation may include discrete analog and/or digital components that are, for example, integrated as part of a printed circuit board. Alternatively, or additionally, the disclosed components or modules may be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

The foregoing description of embodiments has been presented for purposes of illustration and description. The foregoing description is not intended to be exhaustive or to limit embodiments of the present invention(s) to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention(s) in various embodiments and with various modifications as are suited to the particular use contemplated. The features of the embodiments described herein may be combined in all possible combinations of methods, apparatus, modules, systems, and computer program products.

From the foregoing, it will be appreciated that specific embodiments of the invention have been described herein for purposes of illustration, but that various modifications may be made without deviating from the scope of the invention. Accordingly, the invention is not limited except as by the appended claims.

### APPENDIX

Additional details of the VR/AR enabled workstation are disclosed in the text and drawings of the accompanying Appendix (e.g., as shown in FIGS. 6, 7A, 7B, and 8-17), which is incorporated by reference herein.

What is claimed is:

1. A method for manipulating audio tracks in a virtual environment, the method comprising:
displaying, via a virtual reality device, an audio track in the virtual environment;
illustrating the audio track as nodes in the virtual environment;
monitoring a user of the virtual reality device with cameras in the virtual reality device to detect gestures of the user manipulating the nodes;
identifying a gesture of the user manipulating at least one node of the audio track; and
editing the audio track based on the user manipulating the at least one node.

2. The method of claim 1, further comprising:
determining a position of the user in the virtual environment as a mixdown point, wherein a position, a volume, and a movement of the at least one node is determined in relation to the mixdown point.

3. The method of claim 1, further comprising:
integrating a second user into the virtual environment; and
collaborating edits to the audio track by the second user with edits to the audio track by the user.

4. The method of claim 1, further comprising:
generating the virtual environment based on user selected acoustical characteristics of a physical acoustical environment; and
displaying sound waves of the audio track based on the acoustical characteristics.

5. The method of claim 1, further comprising:
displaying a menu with options for the user to select to adjust acoustical characteristics of the virtual environment;
receiving a selection of at least one acoustical characteristic; and
executing the audio track in the virtual environment with the at least one acoustical characteristic.

6. The method of claim 1, further comprising:
monitoring user gestures to identify changes to a shape and a dimension of the virtual environment; and
altering at least one acoustical properties of the virtual environment based on the changes to the shape and the dimension of the virtual environment.

7. The method of claim 1, further comprising:
illustrating sound waves emitted from one or more nodes in the virtual environment, wherein the sound waves reflect and refract from surfaces and objects in the virtual environment.

8. A system comprising:
one or more processors; and
one or more memories storing instructions that, when executed by the one or more processors, cause the system to perform a process for manipulating audio tracks in a virtual environment, the process comprising:
displaying, via a virtual reality device, an audio track in the virtual environment;
illustrating the audio track as nodes in the virtual environment;
monitoring a user of the virtual reality device with cameras in the virtual reality device to detect gestures of the user manipulating the nodes;
identifying a gesture of the user manipulating at least one node of the audio track; and
editing the audio track based on the user manipulating the at least one node.

9. The system according to claim 8, wherein the process further comprises:
determining a position of the user in the virtual environment as a mixdown point, wherein a position, a volume, and a movement of the at least one node is determined in relation to the mixdown point.

10. The system according to claim 8, wherein the process further comprises:
integrating a second user into the virtual environment; and
collaborating edits to the audio track by the second user with edits to the audio track by the user.

11. The system according to claim 8, wherein the process further comprises:
generating the virtual environment based on user selected acoustical characteristics of a physical acoustical environment; and
displaying sound waves of the audio track based on the acoustical characteristics.

12. The system according to claim 8, wherein the process further comprises:
displaying a menu with options for the user to select to adjust acoustical characteristics of the virtual environment;
receiving a selection of at least one acoustical characteristic; and
executing the audio track in the virtual environment with the at least one acoustical characteristic.

13. The system according to claim 8, wherein the process further comprises:
monitoring user gestures to identify changes to a shape and a dimension of the virtual environment; and
altering at least one acoustical properties of the virtual environment based on the changes to the shape and the dimension of the virtual environment.

14. The system according to claim 8, wherein the process further comprises:
illustrating sound waves emitted from one or more nodes in the virtual environment, wherein the sound waves reflect and refract from surfaces and objects in the virtual environment.

15. A non-transitory computer-readable medium storing instructions that, when executed by a computing system, cause the computing system to perform operations for manipulating audio tracks in a virtual environment, the operations comprising:
displaying, via a virtual reality device, an audio track in the virtual environment;
illustrating the audio track as nodes in the virtual environment;
monitoring a user of the virtual reality device with cameras in the virtual reality device to detect gestures of the user manipulating the nodes;
identifying a gesture of the user manipulating at least one node of the audio track; and
editing the audio track based on the user manipulating the at least one node.

16. The non-transitory computer-readable medium of claim 15, wherein the operations further comprise:
determining a position of the user in the virtual environment as a mixdown point, wherein a position, a volume, and a movement of the at least one node is determined in relation to the mixdown point.

17. The non-transitory computer-readable medium of claim 15, wherein the operations further comprise:
integrating a second user into the virtual environment; and
collaborating edits to the audio track by the second user with edits to the audio track by the user.

18. The non-transitory computer-readable medium of claim 15, wherein the operations further comprise:
generating the virtual environment based on user selected acoustical characteristics of a physical acoustical environment; and
displaying sound waves of the audio track based on the acoustical characteristics.

19. The non-transitory computer-readable medium of claim 15, wherein the operations further comprise:
displaying a menu with options for the user to select to adjust acoustical characteristics of the virtual environment;
receiving a selection of at least one acoustical characteristic; and
executing the audio track in the virtual environment with the at least one acoustical characteristic.

20. The non-transitory computer-readable medium of claim 15, wherein the operations further comprise:
monitoring user gestures to identify changes to a shape and a dimension of the virtual environment; and
altering at least one acoustical properties of the virtual environment based on the changes to the shape and the dimension of the virtual environment.
